(19) United States
(12) Patent Application Publication
(10) Pub. No.: US 2026/0360584 A1
(43) Pub. Date: Nov. 12, 2026

(54) TARGET SUBSTRATE LOADING DEVICE AND RADIOISOTOPE PRODUCTION DEVICE

(71) Applicant: SUMITOMO HEAVY INDUSTRIES, LTD., Tokyo (JP)

(72) Inventor: Masayoshi NAGAYASU, Niihama-shi (JP)

(21) Appl. No.: 19/719,944

(22) Filed: Jun. 25, 2026

Related U.S. Application Data
(63) Continuation of application No. PCT/JP2024/042936, filed on Dec. 4, 2024.

(30) Foreign Application Priority Data
Dec. 26, 2023 (JP) 2023-219411

(51) Int. Cl. G21G 1/10; G21K 5/08

(52) U.S. Cl. CPC G21G 1/10; G21K 5/08

(57) ABSTRACT

A target substrate loading device holds a plurality of target substrates each to be loaded into a target device that holds a target substrate to be irradiated with a charged particle beam from a particle accelerator, the plurality of target substrates being arranged in a thickness direction, and automatically feeds the target substrates to the target device.

### CROSS-REFERENCE TO RELATED APPLICATIONS

This is a bypass continuation of International PCT Application No. PCT/JP2024/042936, filed on Dec. 4, 2024, which claims priority to Japanese Patent Application No. 2023-219411, filed on Dec. 26, 2023, which are incorporated by reference herein in their entirety.

### BACKGROUND

### Technical Field

Certain embodiments of the present invention relate to a target substrate loading device and a radioisotope production device.

### Description of Related Art

In the related art, a target device for producing a radioisotope using a solid target is known (for example, see the related art). In this type of target device using a solid target, accelerated particles are introduced from a particle accelerator such as a cyclotron and caused to undergo a nuclear reaction with an element constituting the solid target, thereby generating a radioisotope in the solid target. Then, the solid target that has undergone the nuclear reaction is recovered from the target device, and a radioisotope is obtained by performing a treatment such as dissolving the solid target using a liquid of a strong acid or a strong base.

### SUMMARY

The concept of the present disclosure is in the following [1] to [5].

[1] One or more embodiments provide a target substrate loading device that holds a plurality of target substrates each to be loaded into a target device that holds a target substrate to be irradiated with a charged particle beam from a particle accelerator, the plurality of target substrates being arranged in a thickness direction, and automatically feeds the target substrates to the target device.

[2] In the target substrate loading device according to [1], the target substrate loading device may include a magazine unit that holds the plurality of target substrates arranged in the thickness direction, and a substrate feeder that feeds the target substrates held by the magazine unit to the target device.

[3] In the target substrate loading device according to [2], the substrate feeder may include a substrate discharge hole that is provided below the target substrates held by the magazine unit and through which the target substrates pass and fall, and a magazine driving unit that drives the magazine unit, relative to the substrate discharge hole, in an arrangement direction of the target substrates.

[4] In the target substrate loading device according to [3], the magazine driving unit may include a ratchet that is provided in the magazine unit and includes a plurality of ratchet teeth arranged in the same direction as the target substrates, and a pawl that engages with the ratchet and reciprocates in the arrangement direction of the target substrates.

[5] One or more embodiments provide a radioisotope production device including: the target substrate loading device according to any one of [1] to [4], and the target device that receives and holds the target substrate fed from the target substrate loading device, in which the target substrate held by the target device is irradiated with the charged particle beam to produce a radioisotope.

### BRIEF DESCRIPTION OF THE DRAWINGS

FIG. 1 illustrates a side view schematically showing a radioisotope production device according to an embodiment.

FIG. 2 illustrates a plan view schematically showing the radioisotope production device according to the embodiment.

FIG. 3 illustrates a plan view schematically showing a state in which a target device is opened.

FIG. 4A illustrates a cross-sectional view showing the vicinity of a substrate slot in a state in which the target device is opened, FIG. 4B illustrates a cross-sectional view showing the vicinity of the substrate slot in a state in which the target device is closed, and FIG. 4C illustrates a cross-sectional view taken along a line IVc-IVc in FIG. 4B.

FIG. 5A illustrates a plan view showing a mechanism of a target substrate loading device, and FIG. 5B illustrates a side cross-sectional view of the mechanism of the target substrate loading device.

FIG. 6A illustrates a plan view showing the target substrate loading device in operation, and FIG. 6B illustrates a side cross-sectional view of the target substrate loading device in operation.

FIG. 7A illustrates a plan view showing the target substrate loading device in operation, following FIGS. 6A and 6B, and FIG. 7B illustrates a side cross-sectional view of the target substrate loading device in operation.

FIG. 8A illustrates a plan view showing the target substrate loading device in operation, following FIGS. 7A and 7B, and FIG. 8B illustrates a side cross-sectional view of the target substrate loading device in operation.

### DETAILED DESCRIPTION

Meanwhile, when attaching and detaching a target substrate, which is a solid target, to and from the target device, it is necessary to stop the particle accelerator, confirm that the radioactivity has decreased to a predetermined amount or less, and thereafter have an operator enter the shielded area and perform the operation. Therefore, the operation of setting the target substrate in the target device is accompanied by radiation exposure of the operator each time. It is desirable to provide a target substrate loading device and a radioisotope production device that enable automatic loading of a target substrate into a target device.

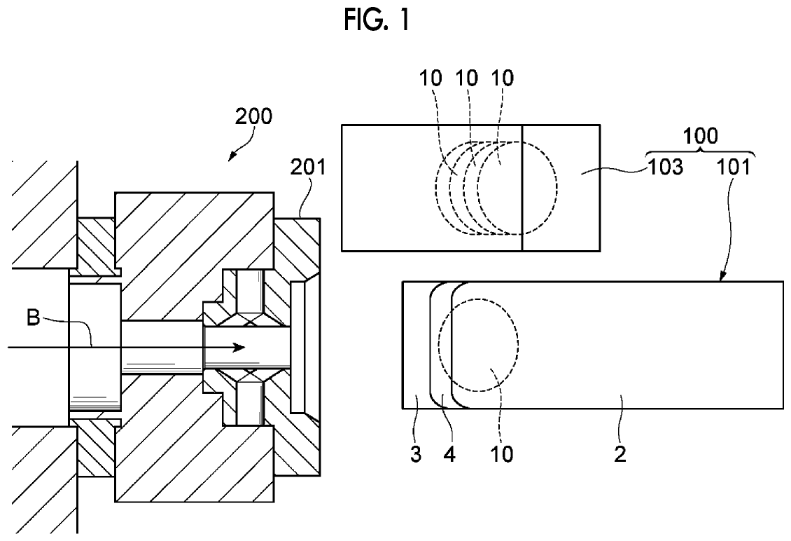

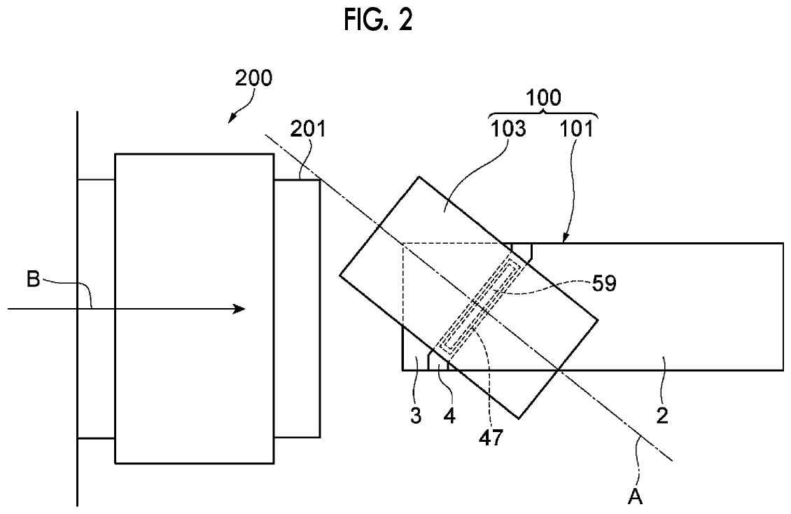

A radioisotope production device 100 according to the present embodiment will be described with reference to the drawings. FIG. 1 is a side view schematically showing the radioisotope production device 100, and FIG. 2 is a plan view of the radioisotope production device 100. As shown in the drawings, the radioisotope production device 100 includes a target device 101 and a target substrate loading device 103 disposed above the target device 101.

The target device 101 is a device that holds the target substrate 10. The target substrate 10 is configured, for example, in an oblong plate shape, and a metal layer made of a target material is formed on a surface of the target substrate 10. In a radioisotope production process, the target substrate 10 is set in the target device 101, and the target device 101 is moved to the left from the state shown in FIGS. 1 and 2. Then, a front end portion of the target device 101 is inserted into the manifold 201 of the particle accelerator 200 and a front end surface of the target device 101 is pressed against a receiving surface of the manifold 201, so that the target device 101 is mounted on the manifold 201 of the particle accelerator 200. The target substrate 10 is held in the target device 101 in a posture inclined around a vertical axis with respect to an irradiating direction of a charged particle beam B. In this state, the target substrate 10 in the target device 101 is irradiated with a charged particle beam B from the particle accelerator 200. A minute amount of a radioisotope is generated by a nuclear reaction of the target material at a portion irradiated with the charged particle beam B.

In the radioisotope production device 100 of the present embodiment, the target substrate 10 is a dissolvable metal target, and the target material can be dissolved at an irradiation position after the irradiation with the charged particle beam B. Then, after the dissolution operation, the target material is transferred in liquid form to a purification apparatus in a hot cell (not shown) in a subsequent process. The metal nuclide purification of such a mechanism can be realized by adding one liquid transfer pipe to an existing facility.

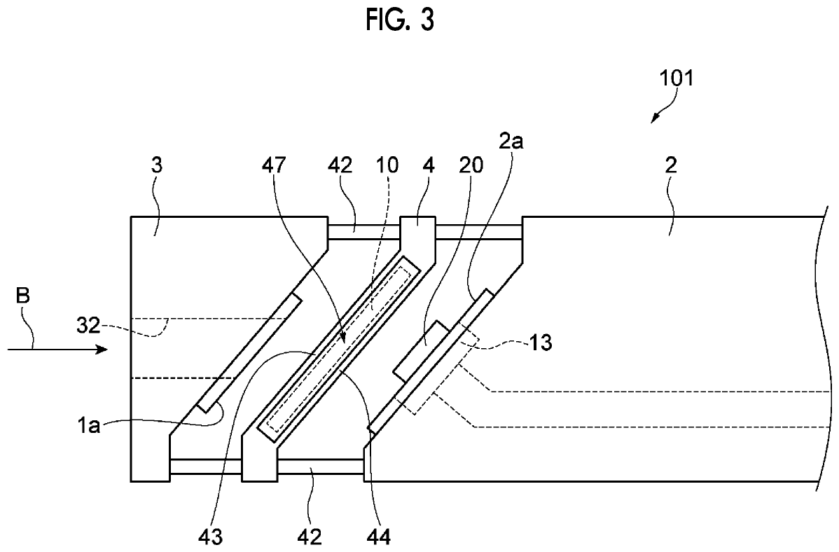

FIG. 3 is a plan view schematically showing a state where the target device 101 is opened. As shown in FIGS. 1 to 3, the target device 101 has a cylindrical shape. The target device 101 includes a main body 2, a front flange 3 that is provided on the front side of the main body 2 (on the upstream side of the charged particle beam B), and an intermediate holder 4 that is provided between the main body 2 and the front flange 3. The main body 2, the intermediate holder 4, and the front flange 3 are divided in the irradiating direction of the charged particle beam B. A joint portion between the main body 2 and the intermediate holder 4 and a joint portion between the intermediate holder 4 and the front flange 3 are present along a vertical plane that intersects obliquely with respect to the irradiating direction of the charged particle beam B.

The front flange 3 is reciprocally movable relative to the main body 2 in the irradiating direction of the charged particle beam B, and the intermediate holder 4 is also reciprocally movable relative to the main body 2 in the irradiating direction of the charged particle beam B. In order to enable such reciprocal movement, the target device 101 is provided with a driving unit (not shown), and a guide bar 42 that guides the movement as described above is provided.

A cooling water circulation hole 13 for cooling the target substrate 10 is formed in the main body 2. In the irradiation process of the charged particle beam B, the cooling water in the cooling water circulation hole 13 comes into contact with and flows on a back surface of the target substrate 10 in the intermediate holder 4, thereby cooling the target substrate 10 that generates heat.

A through-hole 32 through which the charged particle beam B passes is formed in the front flange 3. An O-ring (not shown) is provided on the front surface of the front flange 3 to surround the opening portion of the through-hole 32. In the irradiation process of the charged particle beam B, the front surface of the front flange 3 is pressed against the receiving surface of the manifold 201 (FIG. 1) of the particle accelerator 200, whereby the through-hole 32 is connected to the beam exit port of the particle accelerator 200.

The intermediate holder 4 is a member that holds the target substrate 10. The target substrate 10 is held in the substrate slot 47 of the intermediate holder 4 in a posture inclined around a vertical axis with respect to the irradiating direction of the charged particle beam B. The intermediate holder 4 includes a front plate 43 and a rear plate 44 that are parallel to each other and sandwich the target substrate 10 in the thickness direction. The substrate slot 47 into which the target substrate 10 is loaded is formed as a space between the front plate 43 and the rear plate 44. Since the intermediate holder 4 is not provided with an upper plate and a bottom plate of the substrate slot 47, the intermediate holder 4 alone cannot support the target substrate 10 in the substrate slot 47. A structure for supporting the target substrate 10 in the substrate slot 47 will be described later.

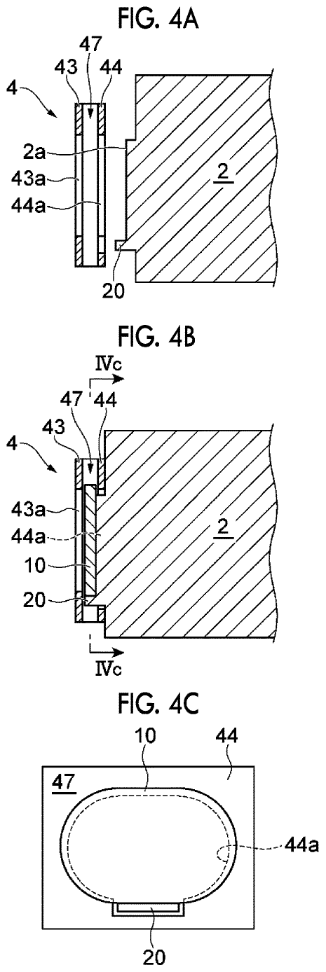

FIG. 4A is a cross-sectional view showing the vicinity of the substrate slot 47 in a state where the target device 101 is opened, FIG. 4B is a cross-sectional view showing the vicinity of the substrate slot 47 in a state where the target device 101 is closed, and FIG. 4C is a cross-sectional view taken along a line IVc-IVc in FIG. 4B. As shown in FIGS. 4A and 4B, a hole 43a having a predetermined shape through which the target substrate 10 cannot pass is formed in the front plate 43. In the irradiation process of the charged particle beam B, a rear surface 3b of the front flange 3 is brought into close contact with a front surface of the target substrate 10 in the substrate slot 47 through the hole 43a, and an opening end surface of the through-hole 32 faces the target material on the target substrate 10. Similarly, a hole 44a having a predetermined shape through which the target substrate 10 cannot pass is formed in the rear plate 44. In the irradiation process of the charged particle beam B, a front surface 2a of the main body 2 is brought into close contact with a rear surface of the target substrate 10 in the substrate slot 47 through the hole 44a, and the cooling water circulation hole 13 is connected to the back surface of the target substrate 10. In this way, in the target device 101, the target substrate 10 is sandwiched between the front flange 3 and the main body 2.

In addition, a flange 20 is formed below the cooling water circulation hole 13 on the front surface 2a of the main body 2. The flange 20 protrudes out of the plane toward the intermediate holder 4 side by a protrusion amount substantially equal to the thickness of the substrate slot 47. When the main body 2 and the intermediate holder 4 are joined to each other, the flange 20 is inserted into the lower end portion of the substrate slot 47 through the hole 44a to form a bottom wall of the substrate slot 47. Then, the target substrate 10 inserted into the substrate slot 47 from above is supported by the flange 20 located at the lower end portion of the substrate slot 47 and remains in the substrate slot 47. In addition, the main body 2 and the intermediate holder 4 are separated from each other in the irradiating direction of the charged particle beam B, so that the flange 20 is removed from the substrate slot 47, and the target substrate 10 that has lost the support falls downward from the substrate slot 47.

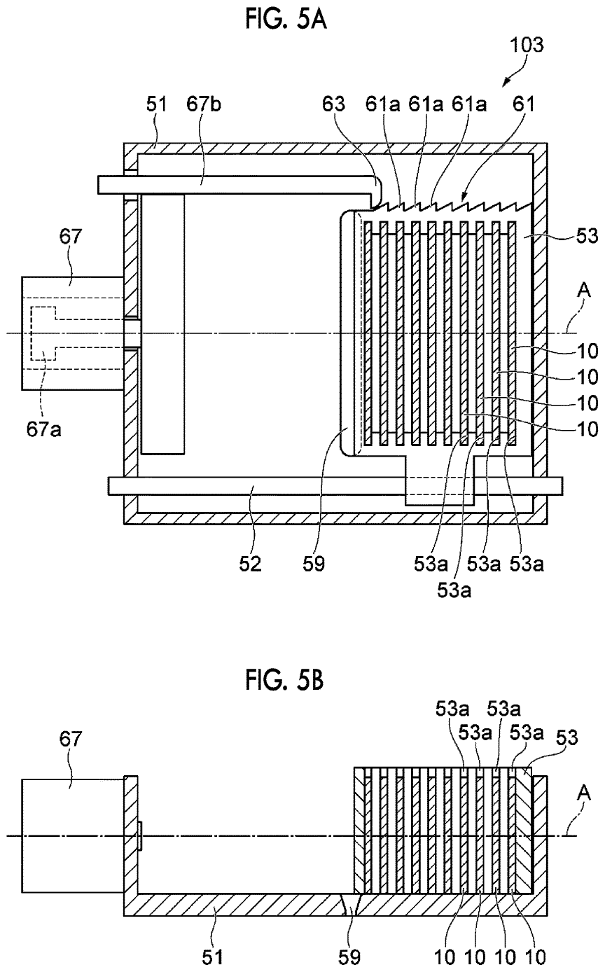

Subsequently, the target substrate loading device 103 will be described. Hereinafter, a reference axis A is set as shown in FIG. 2, and is used to describe a positional relationship between the respective portions. In a plan view, the reference axis A extends in a direction orthogonal to the target substrate 10 held by the target device 101. FIG. 5A is a plan view showing a mechanism of the target substrate loading device 103, and FIG. 5B is a side cross-sectional view of the mechanism of the target substrate loading device. The target substrate loading device 103 is a device that stores a plurality of new target substrates 10 and automatically loads the target substrates 10 one by one into the substrate slot 47 of the target device 101.

The target substrate loading device 103 includes a housing 51, a magazine unit 53 that is provided in the housing 51 and forms a frame body that holds the plurality of target substrates 10, and a substrate feeder 55 that automatically feeds the target substrates 10 held by the magazine unit 53 one by one to the target device 101.

Grooves 53a each capable of accommodating the target substrates 10 one of the target substrates are formed within the frame of the magazine unit 53. The groove 53a can accommodate the target substrate 10 in a vertically standing posture (posture in which a front surface and a back surface form vertical planes), and the target substrate 10 in the groove 53a is orthogonal to the reference axis A. That is, the target substrate 10 is accommodated in the groove 53a with the reference axis A direction as a thickness direction. The target substrate 10 is not firmly held in the groove 53a, and the displacement in the horizontal direction is restricted by the groove 53a, but the movement in the up-down direction is not restricted. A lower end portion of the target substrate 10 accommodated in the groove 53a rests on a bottom surface of the housing 51, and the target substrate 10 is supported by a bottom plate of the housing 51 and remains in the groove 53a. In a case where the bottom plate of the housing 51 is not provided, the target substrate 10 slides down out of the groove 53a.

A plurality of grooves 53a as described above are arranged in the reference axis A direction at a pitch of, for example, about 2 to 3 times the thickness of the target substrate 10. Therefore, the magazine unit 53 holds the plurality of target substrates 10 in a state of being arranged in the thickness direction at a pitch of, for example, about 2 to 3 times the thickness thereof.

The magazine unit 53 is configured to be movable in parallel in the reference axis A direction in the housing 51. Specifically, a guide shaft 52 extending in the reference axis A direction is provided in the housing 51, and a side surface of the magazine unit 53 is slidably engaged with the guide shaft 52. The magazine unit 53 is guided by the guide shaft 52 and is movable in parallel in the reference axis A direction in the housing 51.

The substrate feeder 55 includes a magazine driving unit 57 and a substrate discharge hole 59. The magazine driving unit 57 drives the magazine unit 53 in the reference axis A direction relative to the substrate discharge hole 59. Specifically, the magazine driving unit 57 drives the magazine unit 53 in the reference axis A direction in the housing 51. The magazine driving unit 57 includes a ratchet 61 provided on a side surface of the magazine unit 53 on a side opposite to a guide shaft 52 side, a pawl 63 engaged with the ratchet 61, and a driving device 67 that reciprocates the pawl 63. The ratchet 61 has a plurality of ratchet teeth 61a linearly arranged in the reference axis A direction at the same pitch as the groove 53a. The ratchet teeth 61a are teeth that are inclined only on one side, and the pawl 63 is a ratchet pawl that is caught only on the other side of the ratchet teeth 61a. A ratchet mechanism that moves the magazine unit 53 only in one direction is configured by the ratchet 61 and the pawl 63. In the example of FIGS. 5A and 5B, the ratchet mechanism is provided only on one side surface of the magazine unit 53, but one ratchet mechanism may be provided on each of both side surfaces of the magazine unit 53.

The driving device 67 is fixed to an outer side surface of the housing 51, and for example, an air cylinder is adopted as the driving device 67. The driving device 67 reciprocally drives a piston 67a in the reference axis A direction. The pawl 63 is fixed to the piston 67a of the driving device 67 via a predetermined connecting component 67b, and the driving device 67 can reciprocally move the pawl 63 in the reference axis A direction. The driving device 67 reciprocally moves the pawl 63 with a stroke equal to one pitch of the ratchet teeth 61a, so that one ratchet tooth 61a is pulled by the pawl 63, and the magazine unit 53 can be moved in the reference axis A direction to the left in the drawing. The amount of movement of the magazine unit 53 at this time is the same as one pitch of the arrangement of the target substrates 10. That is, in the example of FIGS. 5A and 5B, the magazine unit 53 moves one pitch in the left direction each time the pawl 63 reciprocates with a stroke of one pitch of the ratchet teeth 61a.

The guide shaft 52 is provided with a spring (not shown) that biases the magazine unit 53 in a direction opposite to the movement direction. When the magazine unit 53 is stopped, the ratchet teeth 61a are pressed against the pawl 63 by the biasing force of the spring, so that the magazine unit 53 is positioned.

The substrate discharge hole 59 is a hole provided in a bottom plate of the housing 51 and penetrating the bottom plate vertically. The substrate discharge hole 59 is an elongated hole extending in a direction orthogonal to the reference axis A direction, and has a size and a shape that allow the vertically oriented target substrate 10 to pass through with a slight gap. Such a substrate discharge hole 59 is present at one location within the movable range of the magazine unit 53.

The operation of the target substrate loading device 103 during operation as described above will be described. During the operation of the target substrate loading device 103, the substrate slot 47 of the target device 101 is positioned vertically below the substrate discharge hole 59, and the target substrate loading device 103 is disposed such that the substrate discharge hole 59 and the substrate slot 47 overlap each other in a plan view. In addition, in the target device 101, the intermediate holder 4 and the main body 2 are joined to each other, and the flange 20 is inserted into the lower end portion of the substrate slot 47.

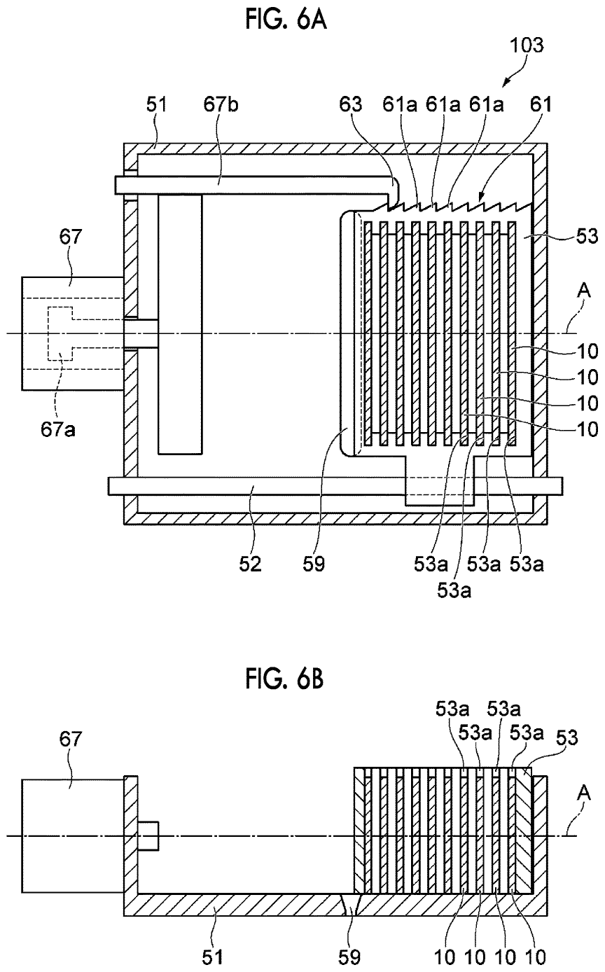

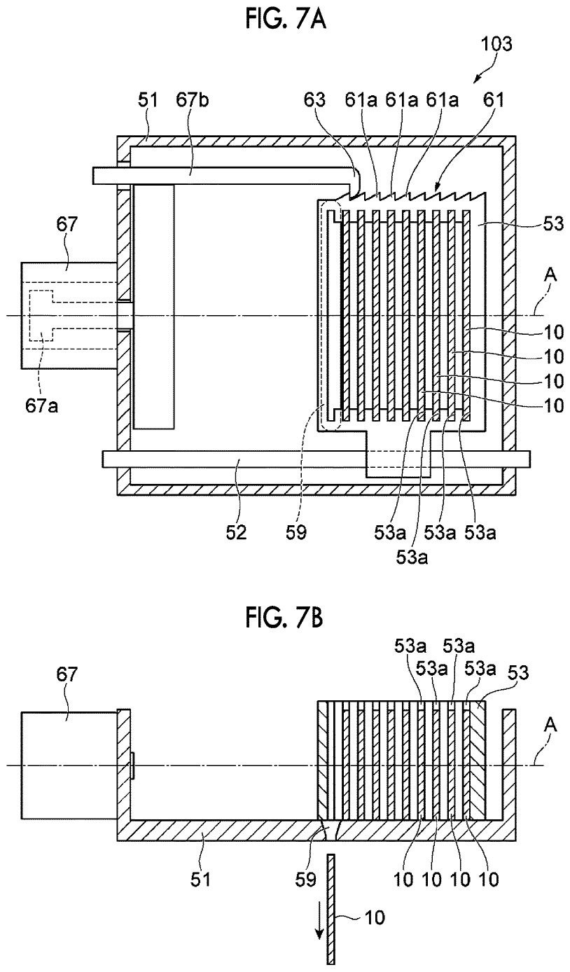

The operation of the target substrate loading device 103 during the operation is as follows. As shown in FIGS. 5A and 5B, at the start of the operation, one target substrate 10 is set in each groove 53a of the magazine unit 53 by prior preparation. From this state, as shown in FIGS. 6A, 6B, 7A, and 7B, when the driving device 67 is driven and the pawl 63 reciprocates once, the magazine unit 53 is moved by one pitch of the ratchet teeth 61a in the reference axis A direction. As a result, the target substrate 10 at the foremost position reaches the position of the substrate discharge hole 59. In this case, as shown in FIGS. 7A and 7B, the target substrate 10 falls into the substrate discharge hole 59, escapes from the magazine unit 53, passes through the substrate discharge hole 59, and falls freely downward. The substrate discharge hole 59 may have a tapered shape as shown in the drawing such that the target substrate 10 smoothly falls into and passes through the substrate discharge hole 59.

The fallen target substrate 10 is fitted into the substrate slot 47 vertically below, and is in a state of being loaded into the substrate slot 47. The target device 101 in which the target substrate 10 is loaded is mounted on the manifold 201 (FIG. 1) of the particle accelerator 200 as described above, and the target substrate 10 is irradiated with the charged particle beam B. After the irradiation with the charged particle beam B, the intermediate holder 4 and the main body 2 are separated from each other in the front-rear direction by a predetermined process, so that the flange 20 is retracted from the substrate slot 47, and the target substrate 10 slides down and is discharged from the substrate slot 47.

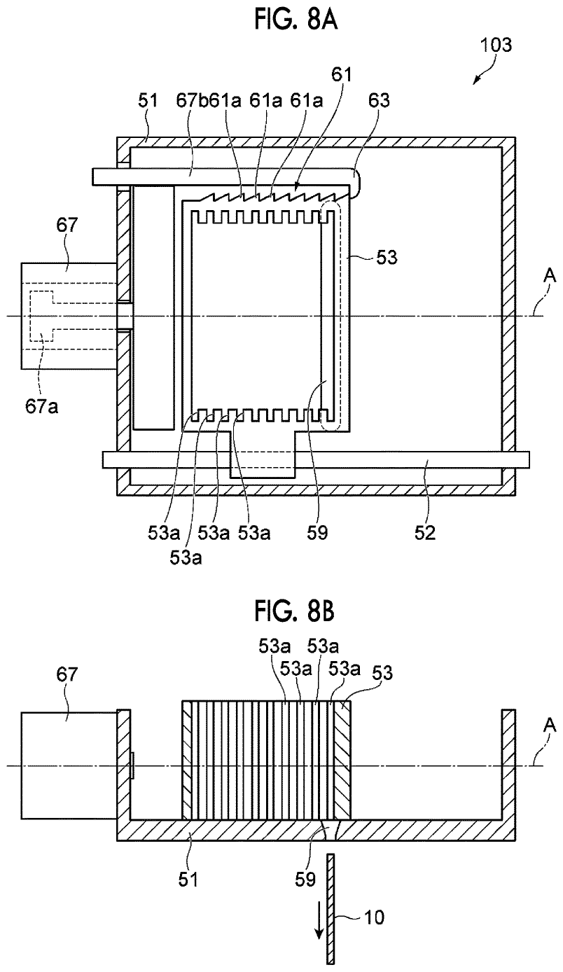

In the next operation, the driving device 67 is driven again, and the magazine unit 53 is moved by one pitch of the ratchet teeth 61a in the reference axis A direction. As a result, the second target substrate 10 from the foremost position passes through the substrate discharge hole 59 and falls, and is fitted into the substrate slot 47 of the target device 101. By repeating the above operation, the target substrate loading device 103 can load the target substrate 10 one by one into the target device 101. Finally, as shown in FIGS. 8A and 8B, when the number of target substrates 10 prepared in advance is exhausted, for example, the operator may manually replenish the magazine unit 53 with the target substrates 10.

The operation and effect of the target substrate loading device 103 described above and the radioisotope production device 100 including the target substrate loading device 103 will be described.

According to the target substrate loading device 103, by driving the driving device 67, the target substrates 10 prepared in advance in the magazine unit 53 can be automatically loaded into the target device 101 one by one. Therefore, it is not necessary to manually load the target substrate 10 into the target device 101, and as a result, it is possible to prevent the operator from being exposed to radiation. In addition, it is not necessary to have skills for disassembling or assembling the target device 101 when loading the target substrate 10.

In addition, in the target substrate loading device 103, the target substrates 10 are arranged in the thickness direction and held in the magazine unit 53. Therefore, a large number of target substrates 10 can be prepared in the target substrate loading device 103 without taking up much space. Therefore, the dimensions of the magazine unit 53 can be kept small, the target substrate loading device 103 can be miniaturized, and the radioisotope production device 100 can be miniaturized.

In addition, since the target substrate 10 is fed by an operation of moving the magazine unit 53 by one pitch at a time by the ratchet mechanism, the operation of automatically loading the target substrate 10 can be realized by a simple driving device such as a reciprocating air cylinder.

The present disclosure can be implemented in various forms with various modifications and improvements based on the knowledge of those skilled in the art, including the above-described embodiment. In addition, it is also possible to form a modification example by using technical matters described in the embodiments described above. The configurations of the respective embodiments or the like may be combined and used as appropriate.

For example, in the embodiment, the target substrate 10 is allowed to fall freely from the target substrate loading device 103 and loaded into the substrate slot 47, but a guide portion that guides the movement of the target substrate 10 due to gravity from the substrate discharge hole 59 of the target substrate loading device 103 to the substrate slot 47 may be provided.

It should be understood that the invention is not limited to the above-described embodiment, but may be modified into various forms on the basis of the spirit of the disclosure. Additionally, the modifications are included in the scope of the disclosure.

What is claimed is:

1. A target substrate loading device that holds a plurality of target substrates each to be loaded into a target device that holds a target substrate to be irradiated with a charged particle beam from a particle accelerator, the plurality of target substrates being arranged in a thickness direction, and automatically feeds the target substrates to the target device.

2. The target substrate loading device according to claim 1, comprising:
a magazine unit that holds the plurality of target substrates arranged in the thickness direction; and a substrate feeder that feeds the target substrates held by the magazine unit to the target device.

3. The target substrate loading device according to claim 2, wherein the substrate feeder includes
a substrate discharge hole that is provided below the target substrates held by the magazine unit and through which the target substrates pass and fall, and
a magazine driving unit that drives the magazine unit, relative to the substrate discharge hole, in an arrangement direction of the target substrates.

4. The target substrate loading device according to claim 3, wherein the magazine driving unit includes
a ratchet that is provided in the magazine unit and includes a plurality of ratchet teeth arranged in the same direction as the target substrates, and
a pawl that engages with the ratchet and reciprocates in the arrangement direction of the target substrates.

5. The target substrate loading device according to claim 4, wherein the magazine driving unit further includes a driving device that reciprocates the pawl.

6. The target substrate loading device according to claim 2, wherein grooves each accommodating the target substrates one of the target substrates are formed within a frame of the magazine unit.

7. The target substrate loading device according to claim 2, further comprising a housing in which the magazine unit is provided.

8. The target substrate loading device according to claim 7, wherein a guide shaft is provided in the housing, and a side surface of the magazine unit is slidably engaged with the guide shaft.

9. A radioisotope production device comprising:
the target substrate loading device according to claim 1; and
the target device that receives and holds the target substrate fed from the target substrate loading device, wherein the target substrate held by the target device is irradiated with the charged particle beam to produce a radioisotope.
